(19) United States
(12) Patent Application Publication
(10) Pub. No.: US 2026/0369029 A1
(43) Pub. Date: Nov. 19, 2026

(54) Multi-Resolution Image Analysis via Diffusion in a Task-Specific Latent Space

(71) Applicant: GDM Holding LLC, Mountain View, CA (US)

(72) Inventors: Aditi Agarwal, Bengaluru (IN); Alok Satish Talekar, Bengaluru (IN); Ishan Shrirang Deshpande, Mountain View, CA (US); Vaibhav Rajan, Bengaluru (IN); Anjali Jain, Bengaluru (IN)

(21) Appl. No.: 19/679,254

(22) Filed: May 15, 2026

(30) Foreign Application Priority Data
May 15, 2025 (IN) 202511046747

(51) Int. Cl. G06V 10/72; G06V 10/26; G06V 10/30; G06V 10/776; G06V 20/10; G06V 20/13

(52) U.S. Cl. CPC G06V 10/72; G06V 10/26; G06V 10/30; G06V 10/776; G06V 20/13; G06V 20/188; G06V 2201/03

(57) ABSTRACT

Provided are systems and methods that operate directly in a feature space (also known as “latent space”) that has been learned by task-specific pre-trained model(s). These task-specific model(s) can in some cases be referred to as “foundational models” (FMs). For example, example techniques can leverage a first encoder model associated with lower-resolution imagery and a second autoencoder model (e.g., containing both an encoder and a decoder) that has been trained to perform a specific image processing task on higher resolution imagery.

### RELATED APPLICATIONS

This application claims priority to and the benefit of India Provisional Patent Application Number IN202511046747, filed May 15, 2025.

### FIELD

The present disclosure relates generally to machine learning processes and machine-learned devices and systems. More particularly, the present disclosure relates to multi-resolution image analysis via diffusion in a task-specific latent space.

### BACKGROUND

In certain image analysis settings, lower-resolution data may be more readily available and/or less costly to obtain, whereas higher-resolution data is less readily available and/or more costly to obtain. Examples of this setting are found in fields such as remote sensing, medical diagnostics, robotics, and others, where low-resolution images can typically be obtained frequently and at low cost, while high-resolution images are available less often due to limitations in acquisition resources or temporal coverage.

Prior approaches to bridging the gap between lower-and higher-resolution imagery often focus on super-resolving images at the pixel level. For example, convolutional neural networks (CNNs), transformers, and generative adversarial networks (GANs), or more recently, diffusion-based models, can be used to upscale low-resolution images to a higher resolution. Task-specific algorithms are then applied on the resulting super-resolved imagery.

Although such methods can create visually plausible outputs, the super-resolution process is typically optimized for perceptual quality or pixel-wise similarity, such as peak signal-to-noise ratio (PSNR) or structural similarity (SSIM). These objectives are misaligned with the needs of downstream analytical tasks, often leading to overly smooth predictions and the potential loss of fine-grained structures.

Furthermore, many earlier methods rely on synthetic downsampling of high-resolution images during training, producing data that lacks the complexity, sensor noise, and genuine variation present in real-world multi-sensor settings. This limits their ability to generalize and deliver reliable task-specific outputs when faced with actual operational data.

### SUMMARY

In an aspect, the present disclosure provides an example method. In some implementations, the example method includes obtaining, by a computing system including one or more computing devices, one or more source images, a reference image, and a target image. In some implementations, at least a portion of the content in each of the one or more source images, the reference image, and the target image depicts an environment. In some implementations, the one or more source images have a first image resolution. In some implementations, the reference image and the target image have a second image resolution that is greater than the first image resolution. In some implementations, the example method includes processing, by the computing system, the one or more source images with a first machine-learned encoder model to generate one or more source image embeddings. In some implementations, the example method includes respectively processing, by the computing system, the reference image and the target image with a second machine-learned encoder model to respectively generate a target image embedding and a reference image embedding. In some implementations, the second machine-learned encoder model has been pre-trained jointly with a machine-learned decoder model to perform an image processing task. In some implementations, the example method includes generating, by the computing system, a noisy version of the target image embedding. In some implementations, the example method includes processing, by the computing system, the noisy version of the target image embedding with a denoising diffusion model that is conditioned on the one or more source image embeddings and the reference image embedding to generate a predicted image embedding. In some implementations, the example method includes modifying, by the computing system, one or more values of one or more parameters of the denoising diffusion model based on a loss function that compares the target image embedding with the predicted image embedding.

In some implementations of the example computer-implemented method, the one or more source images, the reference image, and the target image are aerial images that depict a geographic area. In some implementations of the example computer-implemented method, the one or more source images, the reference image, and the target image are satellite images captured by a satellite and which depict a geographic area. In some implementations of the example computer-implemented method, the one or more source images are captured by a first satellite class, wherein the reference image, and the target image are captured by a second satellite class, and wherein the second resolution is at least 20 times greater than the first resolution. In some implementations of the example computer-implemented method, the one or more source images, the reference image, and the target image include medical images. In some implementations of the example computer-implemented method, the one or more source images, the reference image, and the target image include spatial images captured by robotic devices. In some implementations of the example computer-implemented method, the image processing task includes an image segmentation task. In some implementations of the example computer-implemented method, the image segmentation task includes an agricultural field segmentation task. In some implementations of the example computer-implemented method, the image processing task includes an object detection task or an object recognition task. In some implementations of the example computer-implemented method, the one or more source images depict the environment at a current time, and wherein the reference image depicts the environment at a prior time. In some implementations of the example computer-implemented method, the target image depicts the environment at the current time. In some implementations of the example computer-implemented method, the one or more source images include a plurality of images that depict the environment over a time window. In some implementations of the example computer-implemented method, the one or more source images were captured by a first sensor, and the reference image and the target image were captured by one or more second sensors, the one or more second sensors having greater spatial resolution relative to the first sensor. In some implementations of the example computer-implemented method, the one or more source images include natural images that were captured at the first resolution.

Another aspect provides a computing system for performing an image processing task with improved accuracy. The computing system includes one or more processors and one or more non-transitory computer-readable media that collectively store instructions that, when executed by the one or more processors, cause the computing system to perform operations. The operations include: obtaining, by the computing system, one or more source images and a reference image, wherein the one or more source images and the reference image all depict an environment, wherein the one or more source images have a first image resolution, and wherein the reference image has a second image resolution that is greater than the first image resolution; processing, by the computing system, the one or more source images with a first machine-learned encoder model to generate one or more source image embeddings; processing, by the computing system, the reference image with a second machine-learned encoder model to generate a reference image embedding, wherein the second machine-learned encoder model has been pre-trained jointly with a machine-learned decoder model to perform an image processing task; processing, by the computing system, a noisy input with a denoising diffusion model that is conditioned on the one or more source image embeddings and the reference image embedding to generate a predicted image embedding; and processing, by the computing system, the predicted image embedding with the machine-learned decoder model to generate a task prediction for the image processing task.

In some implementations of the example computing system, the task prediction has the second image resolution. In some implementations of the example computing system, the one or more source images and the reference image are aerial images that depict a geographic area. In some implementations of the example computing system, the one or more source images and the reference image are satellite images captured by a satellite and which depict a geographic area. In some implementations of the example computing system, the one or more source images are captured by a first satellite class, wherein the reference image is captured by a second satellite class, and wherein the second resolution is at least 20 times greater than the first resolution. In some implementations of the example computing system, the one or more source images and the reference image include medical images. In some implementations of the example computing system, the one or more source images and the reference image include spatial images captured by robotic devices. In some implementations of the example computing system, the image processing task includes an image segmentation task. In some implementations of the example computing system, the image segmentation task includes an agricultural field segmentation task. In some implementations of the example computing system, the image processing task includes an object detection task or an object recognition task. In some implementations of the example computing system, the image processing task includes a medical diagnostics task. In some implementations of the example computing system, the image processing task includes a robotics navigation task. In some implementations of the example computing system, the one or more source images depict the environment at a current time, and wherein the reference image depicts the environment at a prior time. In some implementations of the example computing system, the one or more source images include a plurality of images that depict the environment over a time window. In some implementations of the example computing system, the one or more source images were captured by a first sensor and the reference image was captured by one or more second sensors, the one or more second sensors having greater spatial resolution relative to the first sensor.

Another aspect provides one or more non-transitory computer-readable media that collectively store an image-task-specific model, including a first encoder model, a second encoder model, a denoising diffusion model, and a decoder model.

### BRIEF DESCRIPTION OF THE DRAWINGS

FIG. 1A illustrates an example training approach according to example implementations of aspects of the present disclosure;

FIG. 1B illustrates an example diffusion model architecture according to example implementations of aspects of the present disclosure;

FIG. 2 illustrates an example inference approach according to example implementations of aspects of the present disclosure;

FIG. 3 is a flow chart diagram illustrating an example method for training a machine-learned model according to example implementations of aspects of the present disclosure;

FIG. 4 is a block diagram of an example processing flow for using machine-learned model(s) to process input(s) to generate output(s) according to example implementations of aspects of the present disclosure;

FIG. 5 is a block diagram of an example sequence processing model according to example implementations of aspects of the present disclosure;

FIG. 6 is a block diagram of an example technique for populating an example input sequence for processing by a sequence processing model according to example implementations of aspects of the present disclosure;

FIG. 7 is a block diagram of an example model development platform according to example implementations of aspects of the present disclosure;

FIG. 8 is a block diagram of an example training workflow for training a machine-learned model according to example implementations of aspects of the present disclosure;

FIG. 9 is a block diagram of an inference system for operating one or more machine-learned model(s) to perform inference according to example implementations of aspects of the present disclosure;

FIG. 10 is a block diagram of an example networked computing system according to example implementations of aspects of the present disclosure;

FIG. 11 is a block diagram of an example computing device according to example implementations of aspects of the present disclosure; and

FIG. 12 is a block diagram of an example computing device according to example implementations of aspects of the present disclosure.

### DETAILED DESCRIPTION

The present disclosure relates to computer-implemented systems and methods that perform image analysis tasks by applying latent diffusion modeling. In particular, the present disclosure provides systems and methods that operate directly in a feature space (also known as “latent space”) that has been learned by task-specific pre-trained model(s). These task-specific model(s) can in some cases be referred to as “foundational models” (FMs). For example, example techniques can leverage a first encoder model associated with lower-resolution imagery and a second autoencoder model (e.g., containing both an encoder and a decoder) that has been trained to perform a specific image processing task on higher resolution imagery.

Specifically, in some implementations, a low-resolution foundational model (LR-FM) encoder can be trained or pre-trained on low-resolution images, learning to extract embeddings from such lower-resolution data. Separately, an encoder of a high-resolution foundational model (HR-FM) (e.g., which can have been fine-tuned jointly for a specific analytical task such as segmentation) can process detailed high-resolution images, generating latent representations enriched for features important to the particular end task. According to an aspect of the present disclosure, a latent diffusion model can be trained to perform denoising diffusion of embeddings within the latent space of the high-resolution foundational model, while being conditioned on embeddings generated by the low-resolution foundational model.

Training the latent diffusion model can include accessing one or more source (e.g., low-resolution) images, a reference (e.g., historical) high-resolution image, and a target (e.g., ground-truth) high-resolution image. At least a portion of the content in each image can depict the same subject, scene, or other environment. The low-resolution image(s) can be encoded using the LR-FM to produce source embedding(s). The reference and target high-resolution images can be encoded using the HR-FM to produce reference and target embeddings, respectively. The diffusion model takes a noisy version of the target embedding as its input and is conditioned on both the source and the reference embeddings. Throughout a series of denoising steps, the model learns to iteratively remove noise while leveraging the information from both the source embeddings and the reference embeddings, enabling it to predict a clean (or “denoised”) embedding that closely matches the actual target embedding. In particular, a loss function can compare the predicted embedding against the true target embedding, and the model parameters can be updated to reduce the difference.

At inference time, the proposed system does not require access to a contemporaneous high-resolution target image (since this is not generally available in various operational scenarios). Instead, one or more new low-resolution images (e.g., for the desired time or situation) and a historical high-resolution reference image are respectively encoded using the same LR-FM and HR-FM encoders as in training. The latent diffusion model then begins from a noisy initial embedding (e.g., a random noise vector) and is conditioned on the available source and reference embeddings, iteratively refining the noisy input according to the learned denoising process. Once a predicted high-resolution embedding is generated, it can be decoded (e.g., using the decoder from the HR-FM, which may be pre-trained and/or frozen) directly into a task-specific output, such as a segmentation or object detection map (e.g., which may be at the higher resolution).

This approach offers several advantageous features compared to prior techniques. In some implementations, by focusing on embeddings rather than pixel-wise reconstruction, the system can capture and preserve fine detail relevant to analysis tasks even when the original low-resolution data is highly coarse or noisy. It also accommodates large scale disparities—for instance, bridging 20× or greater resolution gaps between sensor types—as frequently encountered in satellite, medical, or industrial imaging applications. Furthermore, the use of real multi-sensor or multi-resolution data during training allows the model to adapt to true operational noise and artifact profiles, improving the consistency and utility of outputs in practice. In addition, by leveraging foundational models that have already been fine-tuned for task performance, the system can avoid the need to train complex autoencoders from scratch, which reduces both the data requirements and risks of misaligned latent spaces.

Thus, the present disclosure allows for temporal and/or contextual conditioning. For example, the reference high-resolution image can depict the environment at a prior time, enabling the model to account for changes over time—such as crop growth, field boundaries, or evolving diagnostic features in medical data. Conditioning the diffusion process on a stack of low-resolution images over a time window can also further improve robustness and context sensitivity. Furthermore, the technique is not limited to segmentation; in some implementations, the final decoder can be replaced or extended to produce other analytical outputs, including object detection bounding boxes, classification labels, or navigation instructions.

The proposed techniques provide a number of technical effects and benefits.

An example technical problem solved by example implementations of aspects of the present disclosure is a loss of task-relevant detail in analytical outputs due to low-resolution image inputs. In fields such as agricultural monitoring, medical diagnostics, and robotics, it is common that high-resolution imagery—e.g., typically required for reliable boundary delineation or object identification—is available only infrequently, while low-resolution images are acquired more regularly but lack sufficient spatial detail. As a result, analytical outputs based on these low-resolution inputs may fail to capture narrow, small, or irregular features (such as agricultural field boundaries, tumorous regions, or small obstacles), leading to inaccuracies in downstream decision-making, resource allocation, or navigation.

Example implementations of aspects of the present disclosure can provide technical solutions to this problem by enabling a computing system to bridge the information gap between low-resolution and high-resolution imagery using task-specific latent diffusion in the embedding space of high-resolution foundation models. The system leverages both temporal context from readily available low-resolution sources and spatial detail from occasional high-resolution reference images. Low-resolution images are processed by a first encoder model to generate source embeddings that encode temporal or environmental changes, while high-resolution reference images are processed by a second, task-optimized encoder to extract detailed embeddings. A denoising diffusion model, conditioned on both these sources, iteratively refines latent representations to produce outputs that retain the finer task-relevant details otherwise absent from low-resolution data alone.

By directly optimizing embeddings for the end analytical task—be it segmentation, detection, recognition, or some other image analysis task—rather than reconstructing images at the pixel level, the approach ensures that small or intricate features (e.g., field boundaries, minute lesions, or discrete navigational obstacles) are recoverable in the output. The use of high-resolution reference embeddings as conditioning signals enhances the system's ability to restore or infer feature boundaries at the necessary level of granularity, resulting in improved per-pixel or per-object analytical accuracy. This benefit is realized at task output resolution matching the high-resolution reference data, thereby remedying prior shortcomings where outputs derived solely from low-resolution inputs would yield merged or missed features.

The solution translates into improved technical performance in environments where it is beneficial to reliably extract features from predominantly low-resolution data. For instance, in precision agriculture, crop segmentation maps generated by the system can correctly delineate narrow or fragmented fields; in medical diagnosis, subtle anatomical or pathological details can be demarcated for clinical review; and in robotics, more accurate and timely identification of boundaries or objects in operational spaces can be achieved. In each domain, the workflow directly supports higher analytical fidelity under constraints of infrequent high-resolution image acquisition, thus addressing a fundamental technical barrier in practical image processing systems.

Another example technical problem solved by example implementations of aspects of the present disclosure may include artifacts and model instabilities arising from training on synthetic low-resolution data that fails to accurately reflect the noise properties and artifacts present in real-world low-resolution sensor acquisitions. In particular, standard machine learning pipelines often create training datasets by downsampling high-resolution images to synthesize low-resolution samples; however, this practice does not mimic genuine sensor noise, environmental variation, or sensor-unique distortions. Consequently, models trained in this way may generalize poorly or produce artifact-laden outputs when deployed on operational, naturally acquired low-resolution data, compromising the system's robustness and reliability.

Example implementations of aspects of the present disclosure can provide technical solutions to this problem by enabling systems to use real, naturally acquired low-resolution images (as opposed to synthetically generated data) to generate embeddings for downstream conditioning in the latent diffusion process. The first encoder model can be designed or pre-trained specifically on real low-resolution images, thereby learning to extract features that inherently account for authentic sensor noise, artifacts, and environmental conditions present in the operational setting. The workflow thus exposes the denoising diffusion model to the actual distribution of variations encountered during inference, aligning training and deployment environments.

Further, by operating primarily in the embedding space rather than on pixel-level reconstructions, the method minimizes the propagation of spurious pixel-wise patterns or resampling artifacts that are characteristic of naïve super-resolution or upsampling approaches. The high-resolution encoder-decoder pair, optimized for the downstream task using real high-resolution reference data, enables the system to focus model capacity on reconstructing or predicting task-important features and boundaries, irrespective of superficial noise variations that might otherwise lead to instability.

This technical configuration results in a model that is more robust to real-world deployment scenarios—such as varying image quality, sensor-specific distortions, or unanticipated environmental changes—thereby reducing the occurrence of boundary artifacts, segmentation instabilities, or misclassified regions under operational conditions. In medical diagnostics, this means segmentation maps or detection results remain reliable even under low-quality imaging; in agricultural applications, field mapping maintains accuracy despite atmospheric distortion in satellite acquisitions; and in robotic vision, navigational outputs resist degradation from fluctuating lighting or sensor idiosyncrasies. Overall, the solution materially improves the technical reproducibility, fidelity, and generalization capacity of image-processing tasks performed on authentic low-resolution data streams.

Various example implementations are described herein with respect to the accompanying Figures.

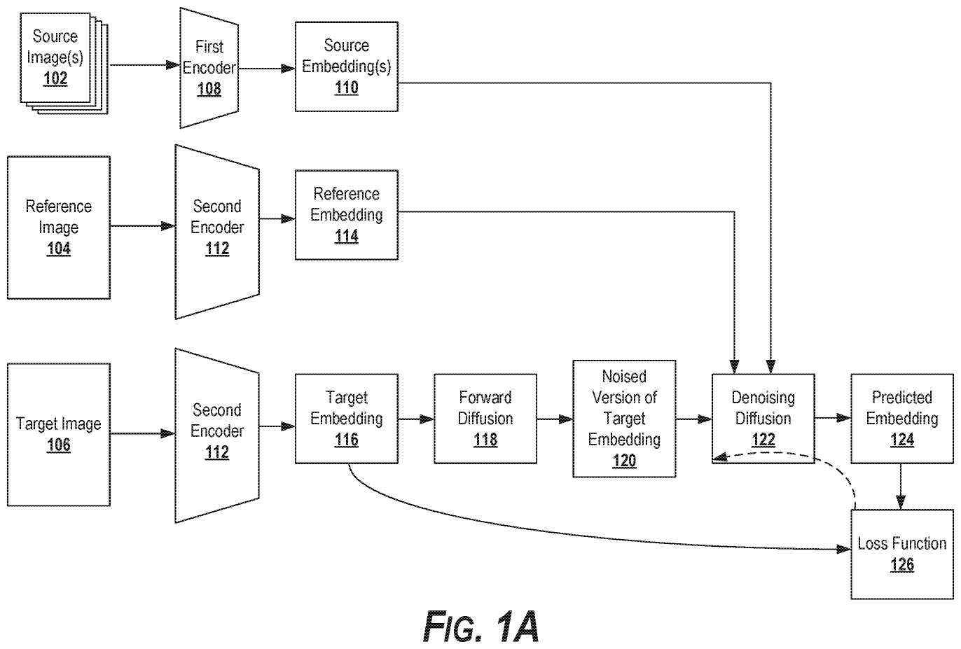

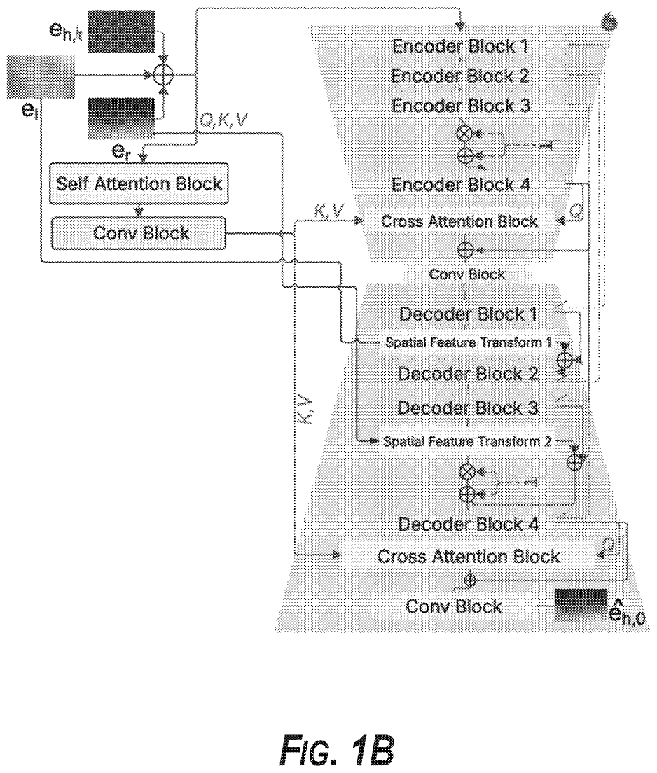

FIG. 1A is a block diagram of an example approach for training a latent diffusion model.

More particularly, the illustrated approach can include obtaining, by a computing system comprising one or more computing devices, one or more source images 102, a reference image 104, and a target image 106. For instance, the one or more source images 102 can include a sequence of low-resolution images acquired at different time points, such as satellite images acquired every few days or portable medical scans taken at regular intervals. The reference image 104 can correspond to a high-resolution image of the same scene or subject, obtained at an earlier or different time, providing additional spatial detail for context. The target image 106 can be a high-resolution image representing the scene or subject at a specific time of interest, and can be used during model training as the ground-truth for optimization. The process of obtaining the imagery can include retrieving data from storage, accessing remote image repositories, interfacing with sensor databases, or directly acquiring images from imaging hardware such as remote sensing satellites, MRI scanners, or robotic cameras.

In some implementations, the one or more source images 102, the reference image 104, and the target image 106 can each depict at least in part the same subject, scene, or other environment, such as a landscape, interior space, medical anatomical region, industrial facility, or other spatial setting. For example, in agricultural monitoring, the source images 102 can include a time series of low-resolution satellite views of farmland, the reference image 104 can correspond to a previously acquired high-resolution satellite snapshot of the same fields, and the target image 106 can be a new high-resolution satellite image of that area. In medical imaging, the environment can be represented by sequential low-resolution scans of a specific body region as source images 102, a previous high-resolution scan as a reference image 104, and a diagnostic high-resolution scan as the target 106. In robotics, the environment can include scenes observed by robot-mounted cameras where low-resolution frames are captured frequently as source images 102, a prior high-resolution frame is used as a reference 104, and a newly acquired high-resolution frame is set as the target 106. The depiction of a shared environment in these images provides spatial and contextual continuity, which can be leveraged when generating or refining embeddings, conditioning diffusion models, or producing downstream task outputs such as segmentation maps, detection results, or navigational information.

In some implementations, the one or more source images 102 can have a first image resolution that is lower than the resolution of the reference image 104 or target image 106 used in the workflow; while the reference image 104 and the target image 106 can have a second image resolution that is greater than the first image resolution of the source images 102. As one example, in agricultural satellite monitoring, the source images 102 can be low-resolution (e.g., 10 meters per pixel) images acquired over time by a certain satellite class or sensor; while the reference image 104 and target image 106 can be high-resolution (e.g., 50 centimeters per pixel) satellite images acquired by a different satellite class or sensor. As another example, in medical applications, the source images 102 can include low-resolution scans from portable or rapid-acquisition devices, which can deliver images with coarse spatial detail; while the reference image 104 and target image 106 can be high-resolution MRI or CT images with finer spatial or anatomical detail. As yet another example, in robotics, the source images 102 can be low-resolution frames captured at high frequency to preserve battery or bandwidth; while less frequent, higher-resolution camera captures can be used as reference image 104 and target image 106 for detailed inspection or navigation tasks.

In some implementations, the approach can include processing the one or more source images 102 with a first encoder 108 to generate one or more source embeddings 110. For example, the first encoder 108 can be a low-resolution foundation model (LR-FM) such as a convolutional neural network or transformer neural network that has been pre-trained on low-resolution imagery. The source images 102, which can be a single image or a temporal sequence depicting scene changes, can be input to the LR-FM to extract a compact latent representation—such as a multi-dimensional tensor embedding that encodes relevant spatial and spectral features. In some implementations, the resulting source embeddings 110 can be resized, tiled, or otherwise formatted as required for downstream conditioning operations. These source embeddings 110 can then be provided as conditioning signals to later stages of a latent diffusion process, where they can help guide denoising or refinement operations according to the temporal context or scene content represented in the low-resolution imagery.

In some implementations, an embedding (e.g., image embedding) corresponds to one or more numerical representations of real-world objects, attributes, or features of content captured and/or depicted in an image, including relationships between items or data points in a dataset.

In some implementations, the approach can include processing the reference image 104 and the target image 106 with a second encoder 112 to generate a reference embedding 114 and a target embedding 116, respectively. For example, the second encoder 112 can be a high-resolution foundation model (HR-FM), which can be pre-trained and fine-tuned for a specific analytical task such as segmentation, detection, or recognition on high-resolution images. The HR-FM encoder can process a reference high-resolution image—such as a prior MRI scan in medical imaging, an earlier-captured 50 cm/px satellite image in agriculture, or a previously acquired high-definition frame in robotics—to generate a reference embedding 114 that encodes spatial and semantic details of the scene or subject at an earlier time. Similarly, during training, the HR-FM can process the target image 106 to yield a target embedding 116 representing the high-detail features aligned with the downstream analysis task. These embeddings 114 116, which can comprise high-dimensional tensors reflecting rich spatial, spectral, or semantic information can subsequently be used to guide or condition downstream processing steps such as denoising diffusion 122, enabling the model to leverage both present and historical context for improved analytical performance.

Thus, in some implementations, the second encoder 112 model can have been pre-trained jointly with a machine-learned decoder model to perform an image processing task. For example, in agricultural segmentation, a high-resolution foundation model can have its encoder and decoder trained together on annotated satellite imagery to optimize for field boundary delineation. In medical imaging, an encoder-decoder pair can be co-trained on high-resolution MRI scans to predict segmentation masks for anatomical structures or disease regions. In robotics, the encoder and decoder can be jointly optimized on high-resolution navigation scenes for generating segmentation maps or object labels. This joint pre-training can be based on supervised objectives, such as minimizing a segmentation loss or detection loss, and can employ datasets where high-resolution images are paired with ground-truth task outputs. By pre-training both components together, the resulting encoder can produce latent embeddings that are specifically tailored for the downstream decoder to generate task-focused outputs, such as per-pixel segmentation, object detection results, or classification scores. The jointly pre-trained encoder and decoder can be incorporated into the larger multi-resolution latent diffusion architecture described herein, enabling the latent diffusion model to generate or refine embeddings that are directly compatible with the task-specific decoder, thus improving the quality of the end task predictions.

In some implementations, the illustrated approach can include generating, by the computing system, a noisy version of the target image embedding 120. For example, during training, the target image embedding 116—produced by encoding the target image 106 using a first encoder 108—can be subjected to a forward diffusion 118 process that gradually adds Gaussian noise over a set number of steps, such as T steps with a noise variance schedule. During training, this noisy version of the target embedding 120 can serve as the input to the denoising diffusion 122 model, which is conditioned on both source embedding 110 and reference embedding 114. In some implementations, the level of noise at each diffusion step can be controlled by a time step indicator, and noise can be sampled using standard Gaussian distributions. This allows the model to learn the mapping from noisy latent representations to denoised, task-aligned embeddings, even when target embedding 116 information is initially degraded or unavailable.

In particular, in some implementations, the illustrated approach can include processing, by the computing system, the noisy version of the target image embedding 120 with a denoising diffusion model 122 that is conditioned on one or more source image embeddings 110 and the reference image embedding 114 to generate a predicted image embedding 124. For instance, during training, the denoising diffusion model 122 can receive as input the noisy embedding produced by applying the forward diffusion process 118 described above. In some implementations, the denoising diffusion model 122 can be structured as a U-Net architecture, which can incorporate conditioning mechanisms such as spatially-adaptive feature transform (SFT) blocks or multi-head self-and cross-attention layers to integrate contextual information from the low-resolution source image embeddings 110 and the reference high-resolution embedding 114.

In some implementations, the illustrated approach can include modifying, by the computing system, one or more values of one or more parameters of the denoising diffusion model 122 based on a loss function 126 that compares the target embedding 116 with the predicted embedding 124. For example, during the training process, after the denoising diffusion model 122 generates the predicted embedding 124 conditioned on the low-resolution and reference high-resolution embeddings, the system can evaluate a loss metric—such as L2 distance, a task-oriented contrastive loss, or some other loss metric—between the predicted embedding 124 and the target embedding 116 produced by the high-resolution foundation model encoder. The computed loss can then be used to update the parameters of the diffusion model through backpropagation or similar optimization algorithms (e.g., stochastic gradient descent), in order to improve the alignment of the predicted embedding 124 with task-relevant features present in the target embedding 116. In some implementations, the loss function 126 can include additional regularization or auxiliary terms to encourage semantic preservation, robust feature matching, and/or to penalize discrepancies that could affect downstream analytical tasks—such as segmentation accuracy or detection reliability. This modification step can be repeated across many training examples and noise levels to incrementally improve the denoising diffusion model's 122 ability to generate embeddings that yield accurate task outputs when decoded by the high-resolution model.

In some implementations, the one or more source images 102, the reference image 104, and the target image 106 can all be aerial images that depict a geographic area, such as satellite, drone, or aircraft-acquired imagery. For example, in agricultural monitoring, the source images 102 can include a time series of low-resolution satellite photographs of farmland captured at intervals of several days, while the reference 104 and target images 106 can be high-resolution images of the same geographic region acquired less frequently by a commercial satellite or aerial survey. In some implementations, these images can cover various landscapes, such as croplands, forests, urban areas, or coastal zones. The system can preprocess these aerial images to align the geographic extents, correct for sensor-specific distortions, or normalize illumination differences. The system can subsequently generate embeddings from these geospatial images using the described low-resolution and high-resolution foundation models. The described latent diffusion process, conditioned on the relevant aerial image embeddings, can then be used to generate task-focused analytical outputs—such as segmentation maps showing field boundaries, detection maps for infrastructure changes, or classification layers for land cover. This approach allows the workflow to address common challenges in geographic analysis, such as varying spatial resolutions, infrequent high-resolution coverage, and temporal gaps, while leveraging the abundance of frequent low-resolution geospatial imagery alongside the detail of occasional high-resolution acquisitions.

In some implementations, the one or more source images 102, the reference image 104, and the target image 106 can include medical images such as MRI, CT, fundus imagery, ultrasound scans, and/or visible light imagery of skin conditions or other anatomical regions of interest. For example, the source images 102 can include a sequence of lower-resolution or lower-intensity medical scans acquired frequently using portable or rapid-acquisition devices, while the reference image 104 can be a previously obtained high-resolution scan (e.g., from a clinical-grade MRI device) providing detailed anatomical or pathological context. The target image 106 can be a high-resolution scan representing the diagnostic ground truth or the state of the anatomy at a later time point. In these implementations, the images can depict regions such as the brain, thorax, abdomen, or musculoskeletal structures, and can capture aspects relevant to disease progression, treatment response, and/or anatomical changes. The workflow can preprocess these medical images by spatially aligning scans, normalizing pixel intensities, or applying corrections for modality-specific artifacts before encoding them with the respective low-resolution or high-resolution foundation models. The latent diffusion process, conditioned on embeddings derived from these medical images, can generate predicted embeddings optimized for downstream medical analytical tasks such as tumor segmentation, lesion detection, or disease classification, without necessitating pixel-level super-resolution. This approach can address limitations commonly encountered in clinical workflows where high-resolution medical imaging is intermittently available and can improve the reliability of analytical outputs even when relying on predominantly low-resolution longitudinal medical data.

In some implementations, the one or more source images 102, the reference image 104, and the target image 106 can include spatial images captured by robotic devices. For example, in the context of robotic navigation or automated inspection, robots can collect frequent low-resolution video frames using on-board cameras to conserve power and bandwidth, while intermittently capturing high-resolution images for detailed assessment. The source images 102 can correspond to a sequence of low-resolution spatial images collected as the robot traverses an environment, such as a factory floor, warehouse, or outdoor terrain (e.g., roadway or other travelway). The reference image 104 can be a previously obtained high-resolution spatial image of a scene, object, or region, used to provide contextual detail and historical reference for analytical tasks. The target image 106 can be a newly captured high-resolution spatial image, used as ground truth for tasks such as obstacle segmentation, defect detection, or feature recognition. In some implementations, the robotic devices can be mobile robots, unmanned ground vehicles, drones, or stationary automation systems equipped with imaging sensors capable of operating at various spatial resolutions. The images captured by such devices can be preprocessed, for example by aligning frames or correcting geometric distortions, before being processed by the described low-and high-resolution foundational models to generate embeddings for the latent diffusion process. This approach enables the described workflow to generate task-specific analytical outputs—such as high-fidelity segmentation maps or detection results—optimized for robotic applications, even when high-resolution spatial data is available only intermittently.

In some implementations, the one or more source images 102 can be captured by a first sensor, and the reference image 104 and the target image 106 can be captured by one or more second sensors, where the second sensors have greater spatial resolution relative to the first sensor. For example, in an agricultural monitoring workflow, the system can obtain temporally distributed low-resolution source images 102 from a wide-swath satellite sensor, while the reference image 104 and target image 106 can be acquired from a commercial very-high-resolution satellite (such as WorldView or GeoEye at 50 centimeters per pixel). In medical imaging scenarios, the first sensor can be a portable device yielding low-intensity, lower-resolution MRI scans, while the second sensor can be a clinical-grade system producing high-resolution scans for the reference image 104 and target image 106. In the robotics field, the source images 102 can be collected by a low-cost, wide-angle camera on a mobile robot, and the reference image 104 and target image 106 can originate from a high-resolution camera system, possibly operating at lower frequency due to power or bandwidth constraints. This multi-sensor configuration allows the system to systematically combine the frequent, broad-coverage or low-cost data from the first sensor with intermittent, detail-rich data from the second sensor(s), benefiting the latent diffusion workflow by providing high-resolution context when available, and improving analytical outcomes in tasks such as segmentation or object detection where fine spatial detail is advantageous.

In some implementations, the one or more source images 102 can include a set of images acquired over a defined time window, depicting the environment at sequential or non-uniform time points. For example, a plurality of low-resolution satellite images 102 of an agricultural region can be collected at regular intervals throughout a growing season to capture crop development or temporal field changes. In medical imaging contexts, the source images 102 can include a temporal sequence of lower-quality scans, such as daily or weekly lower-intensity MRIs showing disease progression or anatomical changes. In robotics, the source images 102 can encompass frames from a video stream or periodic stills collected as a robot navigates through an environment, allowing the model to observe environmental changes over time. The inclusion of a plurality of temporally distributed images as source inputs allows the system to model temporal dynamics, extract trends, or detect state transitions in the environment, which can be beneficial for analytical tasks such as segmentation, object detection, or change detection. The system can preprocess these temporally spaced source images 102, for instance by aligning them spatially, normalizing intensity values across acquisition dates, or stacking them as input channels to the low-resolution foundational model, thereby enabling the latent diffusion process to condition its predictions on multi-date contextual information from the environment over the specified time window.

In some implementations, the one or more source images 102 can include natural images that were originally captured at the first resolution by an imaging device, rather than being synthetically downsampled from higher-resolution data. For example, the system can use low-resolution satellite imagery, such as at 10 meters per pixel, that were directly imaged at that resolution by the satellite sensor. In medical imaging applications, the source images 102 can include scans obtained by portable or rapid-acquisition devices that inherently produce lower-resolution images due to hardware or acquisition constraints. In robotics scenarios, the source images 102 can be low-resolution video frames recorded by built-in cameras, where the capture settings are adjusted to preserve battery or reduce bandwidth usage. The use of natural images captured at their native resolution enables the system to leverage real-world sensor characteristics, including authentic noise patterns, artifacts, and radiometric properties that can otherwise be absent in synthetically downsampled data. This approach can improve the relevance and robustness of the extracted embeddings, as the system is exposed to the inherent variability and distortions present in practical imaging scenarios.

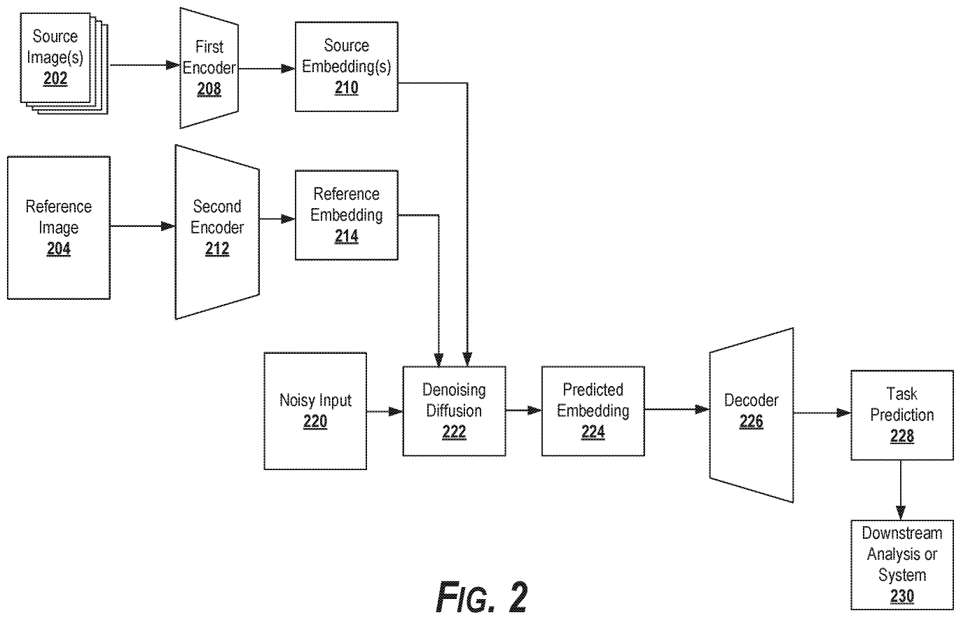

FIG. 2 illustrates an example approach for inference-time denoising in furtherance of an image analysis task. In particular, the illustrated approach can include obtaining, by a computing system, one or more source images 202 and a reference image 204 as the initial step in the workflow. For example, the computing system can retrieve a sequence of low-resolution source images 202, such as periodic multispectral satellite images or low-resolution video frames from a robotics sensor, from local or remote storage systems, sensor networks, or direct data acquisition interfaces. The reference image 204 can be obtained from a source providing higher spatial resolution, such as a commercial satellite provider, a clinical MRI database, or a high-fidelity onboard camera. In some implementations, the computing system can perform automated selection or filtering of which images to obtain based on temporal attributes, quality metrics, spatial coverage requirements, or predefined triggers, such as changes detected in previous low-resolution observations. The system can also include preprocessing routines such as alignment, region-of-interest cropping, or normalization applied to the source images 202 and reference image 204 after acquisition to prepare them for subsequent feature extraction or model input.

In some implementations, the computing system can process the one or more source images 202 with a first machine-learned encoder model 208 to generate one or more source image embeddings 210. For example, the first machine-learned encoder model 208 can correspond to a low-resolution foundation model, such as a convolutional neural network or a transformer architecture, that has been pre-trained on datasets of low-resolution imagery relevant to the application domain, including satellite images at 10 meters per pixel, low-intensity medical scans, or low-resolution video frames in robotics. The source images 202—which can include either a single image or a temporal sequence depicting the same environment at different time points—can be input to the first encoder 208, which processes them to produce a compact feature embedding 210 that encodes salient spatial, spectral, or temporal information. In some implementations, the resulting source image embeddings 210 can be further resized, tiled, or reformatted as needed for downstream compatibility, such as aligning with the spatial dimensions of embeddings from a high-resolution model. These embeddings 210 can then serve as conditioning signals in subsequent stages, for example guiding a latent diffusion model responsible for refining higher-resolution embeddings in analytical tasks like segmentation, detection, or recognition.

In some implementations, the computing system can process the reference image 204 with a second encoder 212 to generate a reference embedding 214. For example, the reference image 204, which can be a high-resolution image depicting an environment at an earlier or different time compared to the target image, can be input into a high-resolution foundation model (HR-FM) encoder that has been pre-trained and optionally fine-tuned for a specific image analysis task, such as segmentation, object detection, or recognition. The HR-FM encoder can extract a high-dimensional latent embedding from the reference image 204, which can encapsulate detailed spatial, spectral, and semantic features of the environment relevant to the analytical task. This reference embedding 214 can then serve as a conditioning signal in subsequent model components, such as a denoising diffusion 222, guiding the refinement or generation of high-resolution latent representations that are aligned with historical spatial context and beneficial for downstream analysis or system 230.

In some implementations, the computing system can process a noisy input 220 with a denoising diffusion model 222 that is conditioned on the one or more source image embeddings 210 and the reference image embedding 214 to generate a predicted image embedding 224. For example, a randomly sampled noisy tensor, or a noisy version of a target image embedding, can be input to a denoising diffusion model 222 implemented with a U-Net architecture. This model can utilize spatially-adaptive feature transform (SFT) blocks or multi-head attention mechanisms to incorporate conditioning signals from the source image embeddings 210—derived from the low-resolution foundational model—and the reference image embedding 214—generated by the high-resolution foundational model encoder. The conditioning can be incorporated throughout the diffusion model 222 using feature concatenation, cross-attention modules, and/or adaptive normalization layers. During iterative denoising steps, the model can progressively refine the noisy input 220 by reducing noise in accordance with a diffusion time-step schedule, ultimately generating a predicted image embedding 224 that lies within the latent space of the high-resolution foundational model. The resulting predicted embedding 224 can then be decoded for downstream analytical tasks, such as segmentation, detection, or recognition, depending on the configuration of the subsequent decoder 226.

In some implementations, the example computing system can process the predicted image embedding 224, generated by the latent diffusion model, with a machine-learned decoder 226 model to produce a task prediction 228 corresponding to the image processing task. For instance, after the denoising diffusion model 222 outputs a predicted embedding 224 in the latent space of the high-resolution foundation model, this embedding can be provided as input to a decoder 226 that has been pre-trained or fine-tuned for specific analytical tasks such as segmentation, object detection, or classification. This step can be realized using a decoder 226 architecture corresponding to the high-resolution foundation model, such as a convolutional network, a transformer-based decoder, or a task-specific neural network. By processing the predicted embedding 224 with the decoder 226, the system can generate outputs that are directly aligned with the requirements of the downstream analytical task, without reconstructing a high-resolution image at the pixel level.

In some implementations, the task prediction 228 generated by processing the predicted image embedding with the machine-learned decoder 226 model can have the second image resolution, corresponding to the higher resolution associated with the reference 204 image. For example, when the denoised embedding is passed to the decoder 226 of the high-resolution foundation model (HR-FM), the resulting task output—such as a segmentation map, detection result, or classification prediction—can be produced at the spatial granularity of the high-resolution input, such as 50 centimeters per pixel for satellite imagery or the clinical-resolution of MRI scans. This means that, even though the system is conditioned on source embeddings 210 from lower-resolution image data, the analytical output is rendered at the higher resolution, enabling finer-grained delineation of features, boundaries, or objects in the depicted environment.

In some implementations, the image processing task handled by the example computing system can include an image segmentation task, where a segmentation map is generated as the primary output. For example, the decoder 226 portion of the high-resolution foundational model can be configured to output a per-pixel label map that delineates spatial structures such as agricultural field boundaries in high-resolution satellite imagery, anatomical regions in medical imaging, or areas of operational interest in robotic environments. The segmentation task can include mapping each pixel to a defined category, such as crop type, organ boundary, or navigable surface, depending on the application context. In this workflow, the predicted embedding 224 produced by the latent diffusion process is directly decoded into a segmentation map, bypassing the need for pixel-level image reconstruction. In some implementations, labeled datasets, such as agricultural field boundary datasets or clinical segmentation masks, can be used to train or evaluate the model, enabling the system to optimize performance for the segmentation task. This approach allows segmentation tasks to be addressed even when high-resolution data is infrequent, by leveraging multi-temporal low-resolution context and high-detail reference images through the described latent diffusion process.

In some implementations, the image segmentation task can include an agricultural field segmentation task, where the goal is to delineate the boundaries of individual agricultural fields using multi-resolution remote sensing data. For example, the system can use frequent low-resolution satellite images as input to capture temporal dynamics across an agricultural landscape, while employing infrequent high-resolution images (such as those at 50 centimeters per pixel) to provide detailed spatial reference image 204 for accurate field boundary extraction. The low-resolution images can be encoded with a low-resolution first encoder 208 to obtain source embedding 210 that reflect recent changes and crop development, while the high-resolution reference image 204 and target images can be encoded with a high-resolution second encoder 212 fine-tuned for agricultural segmentation, capturing granular spatial features including narrow or irregular field edges and smallholder farm parcels. The latent denoising diffusion 222 process can operate in the embedding space of the high-resolution foundation model, progressively refining a noisy input 220 into a predicted embedding 224 that is optimized for decoding into a high-resolution per-pixel segmentation map. When processed by the high-resolution model's decoder 226, the predicted embedding 224 can yield segmentation maps that clearly assign each pixel to a specific field parcel, enabling efficient mapping of field boundaries, even under conditions of extreme field fragmentation and mixed cropping.

In some implementations, the image processing task performed by the described system can include an object detection task or an object recognition task. For example, rather than outputting a segmentation map, the decoder 226 of the high-resolution foundation model (HR-FM) can be replaced or supplemented with an object detection head that outputs bounding boxes and class labels, or with a recognition classifier that assigns category labels to features represented in the high-resolution embedding produced by the latent diffusion process. In agricultural remote sensing, this configuration can enable detection and localization of specific crop types, farm equipment, or infrastructure in high-resolution satellite imagery, with conditioning from temporally-rich low-resolution data. In medical imaging, the system can be adapted so that the high-resolution decoder 226 outputs the locations and identities of detected anatomical structures or lesions in MRI or CT scans, facilitating clinical diagnostics where the presence or absence of objects is relevant. For robotics or industrial inspection, the recognition or detection head can identify and localize obstacles, components, or defects in high-resolution spatial images, supporting tasks such as navigation or quality control. The object detection or recognition head can comprise, for instance, a neural network module such as a convolutional detection architecture or a transformer-based classifier, which is pre-trained or fine-tuned for the specific object categories or classes pertinent to the application domain.

In some implementations, the image processing task performed by the described computing system can include a medical diagnostics task. For example, the decoder 226 associated with the high-resolution foundational model can be configured to produce outputs directly relevant to medical diagnostics, such as disease classification scores, lesion segmentation masks, or the identification of pathological features in MRI, CT, or ultrasound images. In these implementations, the system can use frequently acquired low-resolution medical scans—such as portable MRI or lower-intensity imaging devices—as source inputs, while a clinical-grade high-resolution scan serves as the reference image 204 and, during training, as the target image. The latent diffusion process can operate in the embedding space of a high-resolution model that has been pre-trained or fine-tuned on medical diagnostic tasks, taking into account both the temporal context from the low-resolution scans and detailed spatial features from the reference scan. The predicted embedding 224 generated by the diffusion model can then be decoded to yield diagnostic outputs such as probability of disease, severity indices, or per-pixel maps highlighting anatomical abnormalities. In some implementations, the diagnostic head can comprise a neural network module specialized for clinical outcome prediction, classification of specific pathologies, or risk stratification based on the extracted features.

In some implementations, the image processing task can include a robotics navigation task, where the system generates navigational outputs such as obstacle maps, spatial segmentations, or environmental representations that facilitate autonomous robotic movement. For example, in a mobile robotics scenario, one or more frequently acquired low-resolution images—such as video frames from a robot-mounted camera operating at reduced resolution for power conservation—can be processed by the low-resolution foundational model to capture the recent spatial context of the environment. A high-resolution reference image 204, such as an infrequently acquired detailed frame of the environment or a prior inspection point, can be processed by the high-resolution foundational model to supply fine-grained spatial and structural cues. The latent diffusion process can then operate in the high-resolution model's embedding space, generating a predicted embedding 224 optimized for navigation-related analytical tasks through conditioning on both low-resolution and reference embeddings. The decoder 226 or prediction head can output navigation-focused results, for instance, a per-pixel traversability map, obstacle segmentation, free-space indicator, or detection of key features required for localization and path planning. In some implementations, the navigational output can support two-dimensional or three-dimensional robot movement, and can be further integrated into higher-level decision systems for route optimization or collision avoidance.

The downstream analysis or system 230 can be structured to leverage task predictions for a wide array of applications across different domains, transforming these predictions into practical insights or actions. For instance, in agricultural settings, the task prediction might be a segmentation map delineating crop fields, which the system 230 could use for precision agriculture tasks such as optimizing irrigation schedules, performing yield estimations, or executing targeted pest control measures. In environmental science, it could facilitate watershed analysis by using land cover segmentation maps to predict water flow paths, monitor erosion, or assess flood risks. In urban planning, the system might utilize segmentation maps to analyze infrastructure layouts, guide zoning decisions, or optimize traffic patterns. For wildlife conservation, task predictions indicating habitat boundaries could support the creation of habitat management plans or corridor designs for animal movement. In the medical field, segmentation maps of anatomical structures could be employed by system 230 to assist in treatment planning, active surgical navigation, or in monitoring disease progression in longitudinal studies. In industrial applications, segmentation maps could guide automated inspection systems to identify defects, optimize manufacturing processes, or improve quality control protocols. In robotics, navigational maps generated by task predictions could aid in real-time path planning, obstacle avoidance, or autonomous delivery systems. Each of these examples highlights the capacity of system 230 to transform task predictions into actionable insights, catered to specific operational needs.

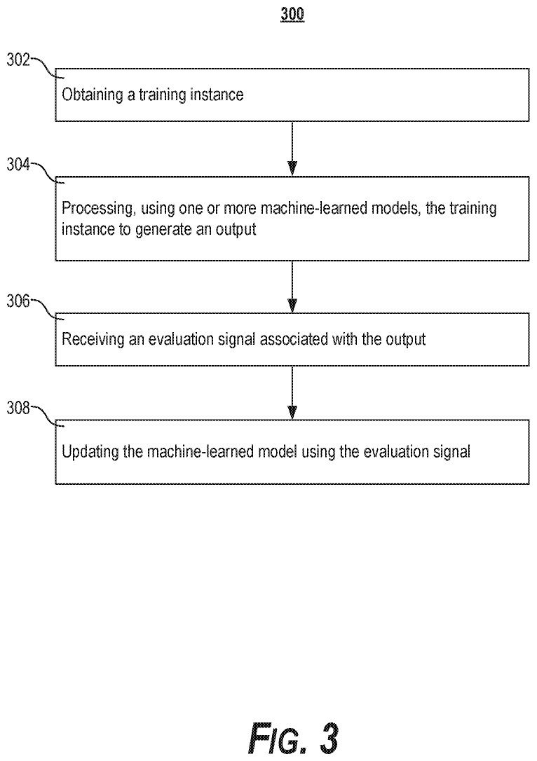

FIG. 3 depicts a flowchart of a method 300 for training one or more machine-learned models according to aspects of the present disclosure. For instance, an example machine-learned model can include a task-specific foundational model. A task-specific foundational model is a pre-trained or fine-tuned machine learning model, designed to operate within a target domain by learning a feature space optimized for specific analytical tasks. These models can capture domain-relevant information by leveraging extensive data sets, often focusing on attributes important for tasks such as image segmentation, object detection, or classification. Through training on high-resolution imagery or detailed data representations, task-specific foundational models develop embeddings that enrich analysis accuracy and facilitate efficient downstream processing. They serve as a basis for extracting and processing complex features, enabling task-oriented outcomes with improved precision and contextual adaptability across diverse applications. Another example model is a denoising diffusion model.

One or more portion(s) of example method 300 can be implemented by a computing system that includes one or more computing devices such as, for example, computing systems described with reference to the other figures. Each respective portion of example method 300 can be performed by any (or any combination) of one or more computing devices. Moreover, one or more portion(s) of example method 300 can be implemented on the hardware components of the device(s) described herein, for example, to train one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of example method 300 can be performed additionally, or alternatively, by other systems.

At 302, example method 300 can include obtaining a training instance. A set of training data can include a plurality of training instances divided between multiple datasets (e.g., a training dataset, a validation dataset, or testing dataset). A training instance can be labeled or unlabeled. Although referred to in example method 300 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 304, example method 300 can include processing, using one or more machine-learned models, the training instance to generate an output. The output can be directly obtained from the one or more machine-learned models or can be a downstream result of a chain of processing operations that includes an output of the one or more machine-learned models.

At 306, example method 300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 308, example method 300 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 300 can include implementing a number of generalization techniques (e.g., weight decays, dropouts, etc.) to improve the generalization capability of the models being trained.

In some implementations, example method 300 can be implemented for training a machine-learned model from an initialized state to a fully trained state (e.g., when the model exhibits a desired performance profile, such as based on accuracy, precision, recall, etc.).

In some implementations, example method 300 can be implemented for particular stages of a training procedure. For instance, in some implementations, example method 300 can be implemented for pre-training a machine-learned model. Pre-training can include, for instance, large-scale training over potentially noisy data to achieve a broad base of performance levels across a variety of tasks/data types.

In some implementations, example method 300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 300 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 300 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

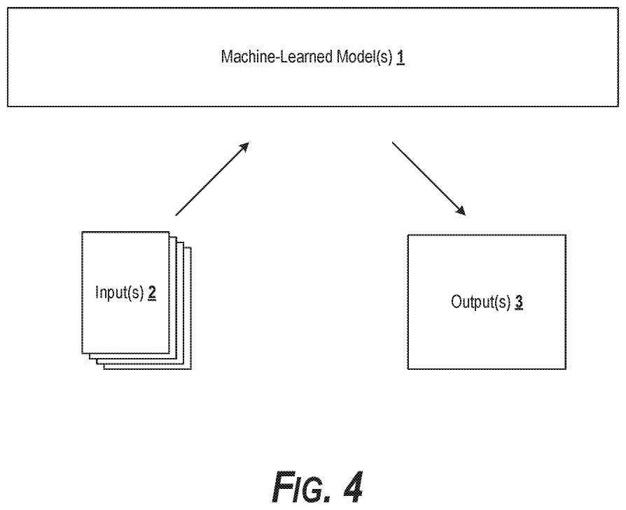

FIG. 4 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of any machine-learned component described herein. Although various features, variations, and implementations described below are described with respect to machine-learned model(s) 1, it is to be understood that such features, variations, and implementations are to be understood as described with respect to each of any machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

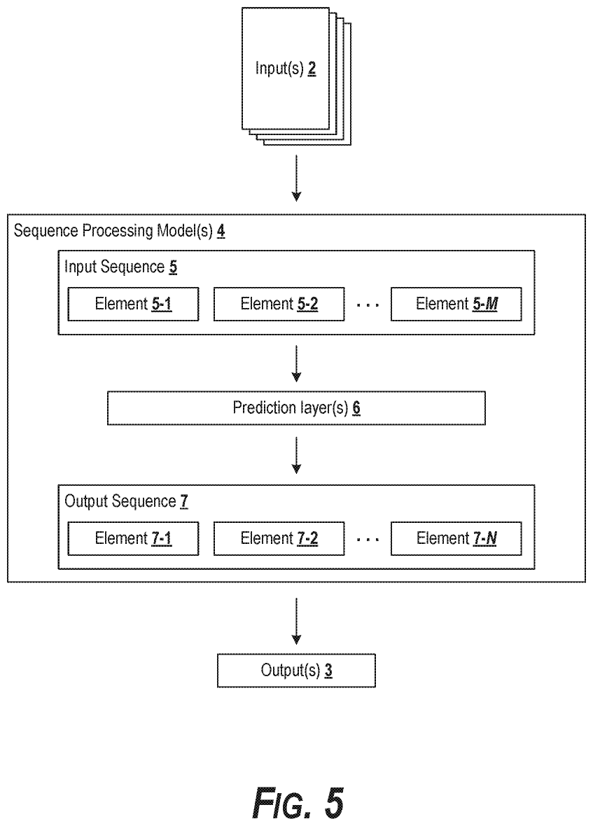

FIG. 5 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE,https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct.31-Nov. 4, 2018), https://aclanthology.org/D 18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 5 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

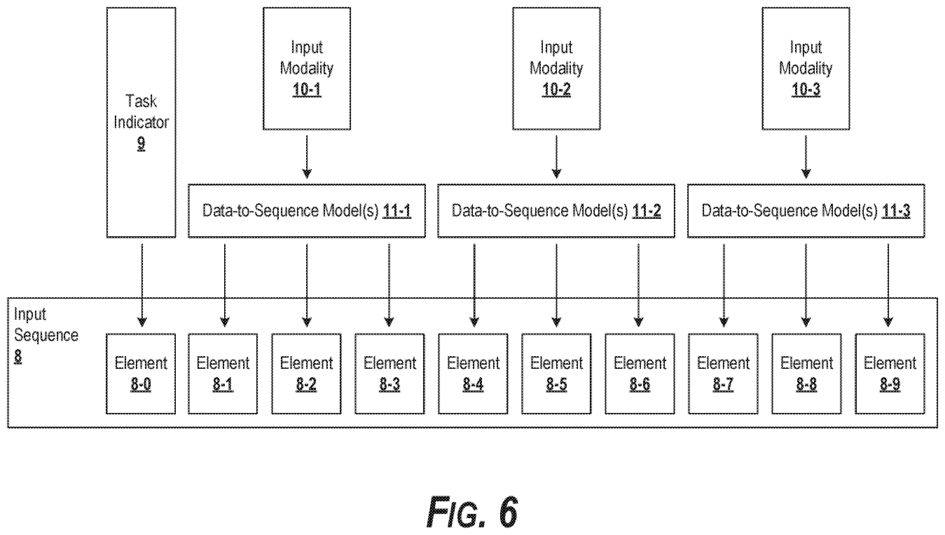

FIG. 6 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

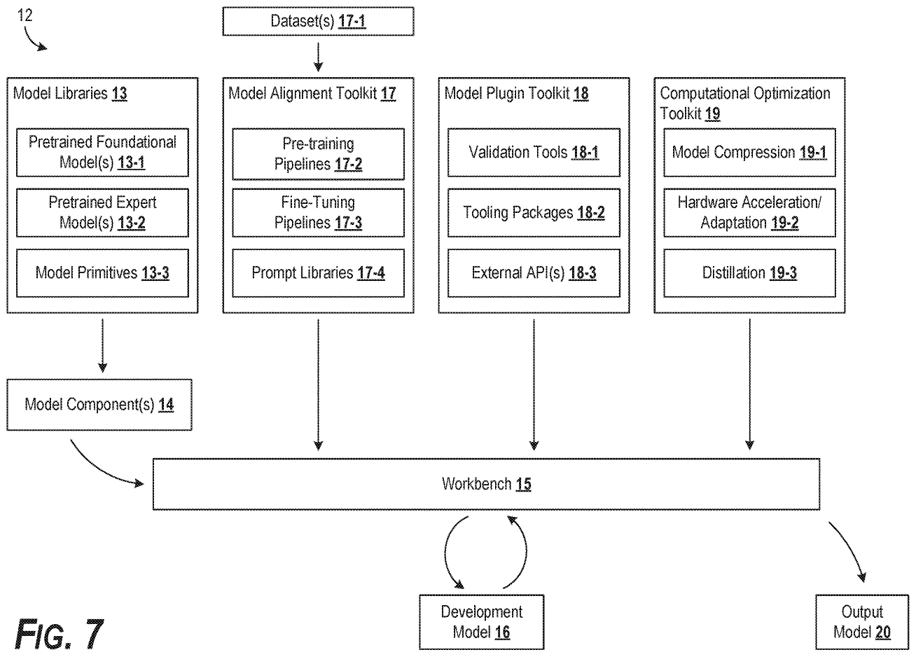

FIG. 7 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

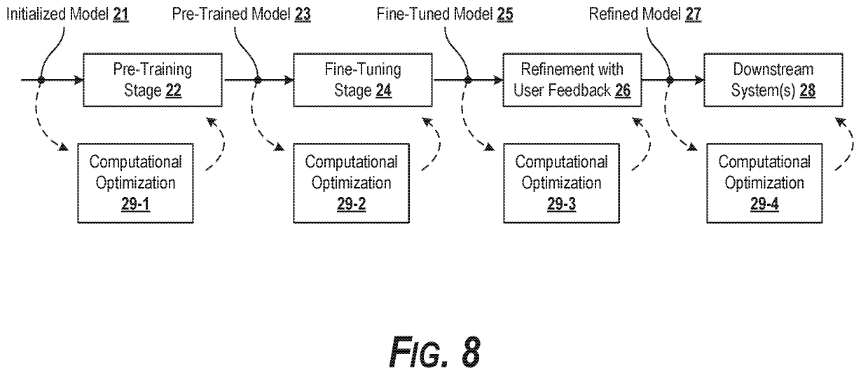

FIG. 8 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

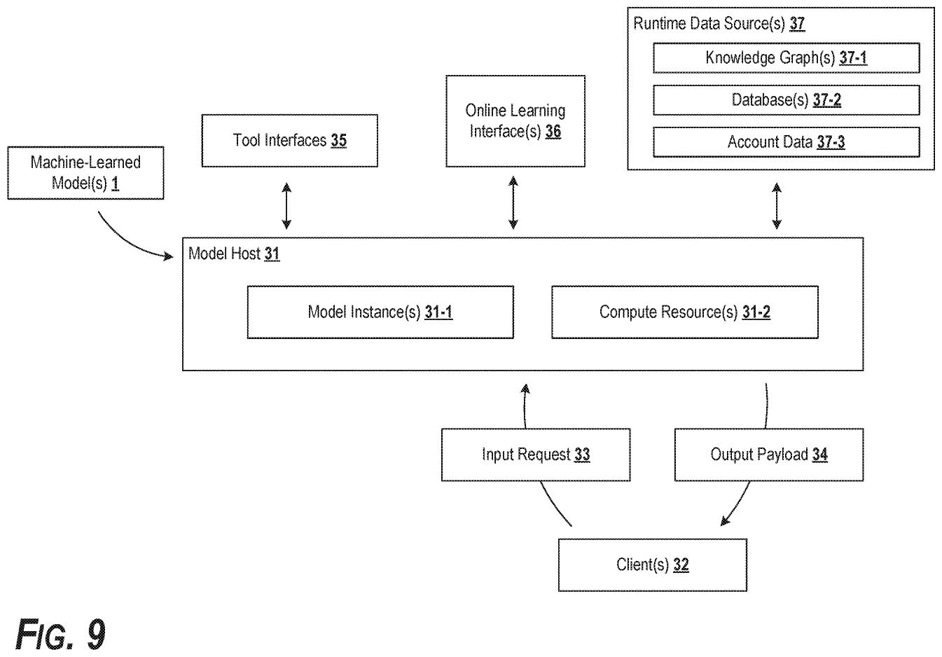

FIG. 9 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

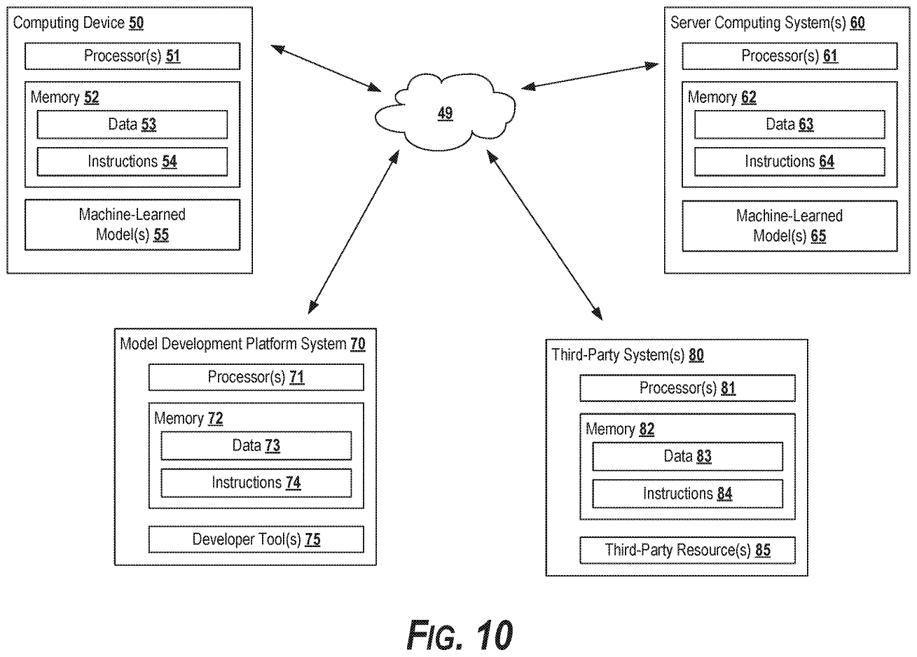

FIG. 10 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 10 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 10illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

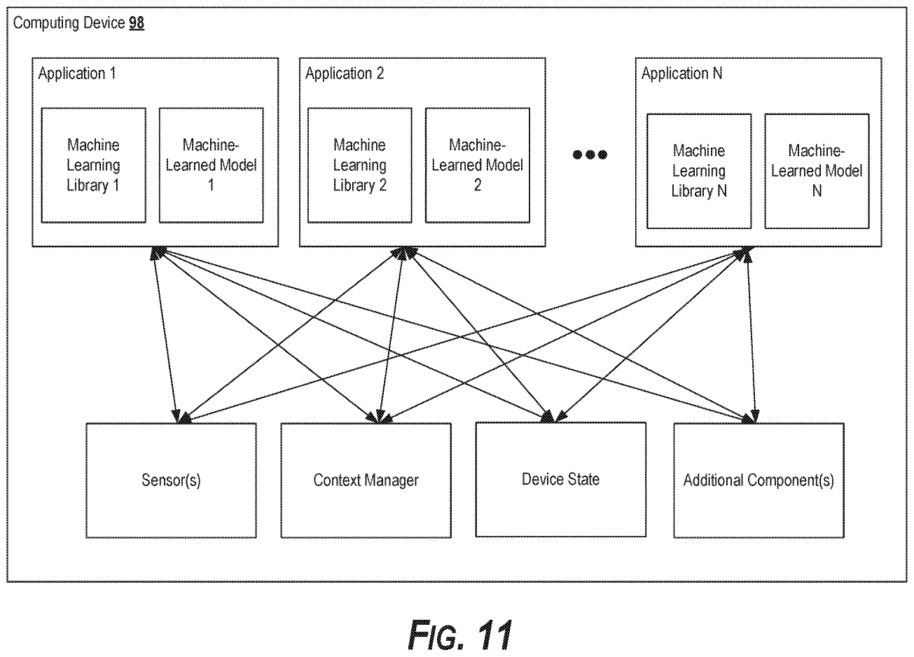

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

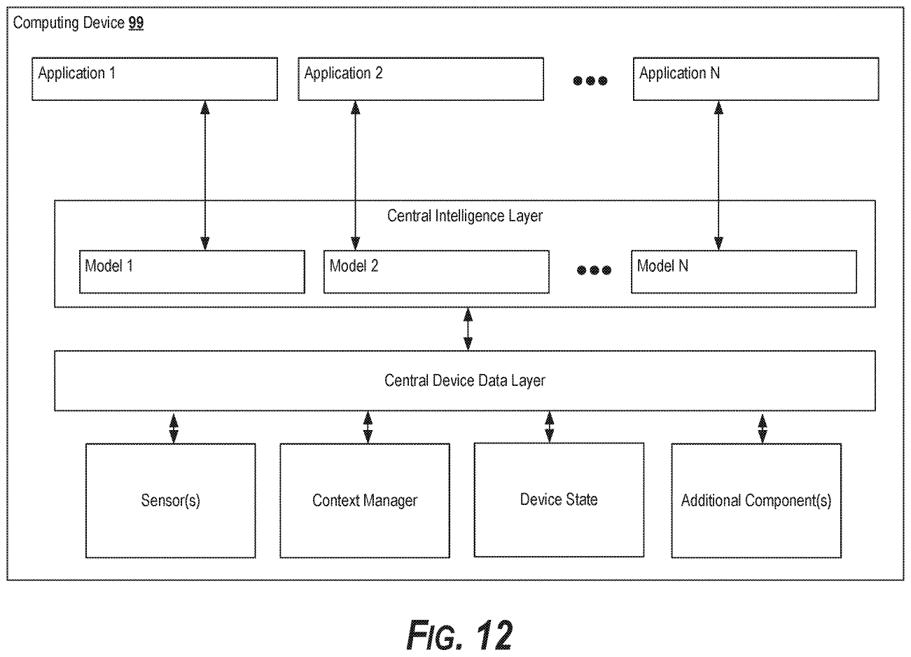

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for image-task-specific latent diffusion with multi-resolution data, the method comprising:
obtaining, by a computing system comprising one or more computing devices, one or more source images, a reference image, and a target image,
wherein at least a portion of the content in each of the one or more source images, the reference image, and the target image depicts an environment,
wherein the one or more source images have a first image resolution, and
wherein the reference image and the target image have a second image resolution that is greater than the first image resolution;
processing, by the computing system, the one or more source images with a first machine-learned encoder model to generate one or more source image embeddings;
respectively processing, by the computing system, the reference image and the target image with a second machine-learned encoder model to respectively generate a target image embedding and a reference image embedding,
wherein the second machine-learned encoder model has been pre-trained jointly with a machine-learned decoder model to perform an image processing task;
generating, by the computing system, a noisy version of the target image embedding;
processing, by the computing system, the noisy version of the target image embedding with a denoising diffusion model that is conditioned on the one or more source image embeddings and the reference image embedding to generate a predicted image embedding; and
modifying, by the computing system, one or more values of one or more parameters of the denoising diffusion model based on a loss function that compares the target image embedding with the predicted image embedding.

2. The computer-implemented method of claim 1, wherein the one or more source images, the reference image, and the target image are aerial images that depict a geographic area.

3. The computer-implemented method of claim 1, wherein the one or more source images, the reference image, and the target image are satellite images captured by a satellite and which depict a geographic area.

4. The computer-implemented method of claim 3, wherein the one or more source images are captured by a first satellite class, wherein the reference image, and the target image are captured by a second satellite class, and wherein the second resolution is at least 20 times greater than the first resolution.

5. The computer-implemented method of claim 1, wherein the one or more source images, the reference image, and the target image comprise medical images.

6. The computer-implemented method of claim 1, wherein the one or more source images, the reference image, and the target image comprise spatial images captured by robotic devices.

7. The computer-implemented method of claim 1, wherein the image processing task comprises an image segmentation task.

8. The computer-implemented method of claim 7, wherein the image segmentation task comprises an agricultural field segmentation task.

9. The computer-implemented method of claim 1, wherein the image processing task comprises an object detection task or an object recognition task.

10. The computer-implemented method of claim 1, wherein the one or more source images depict the environment at a current time, and wherein the reference image depicts the environment at a prior time.

11. The computer-implemented method of claim 10, wherein the target image depicts the environment at the current time.

12. The computer-implemented method of claim 1, wherein the one or more source images comprise a plurality of images that depict the environment over a time window.

13. The computer-implemented method of claim 1, wherein the one or more source images were captured by a first sensor, and the reference image and the target image were captured by one or more second sensors, the one or more second sensors having greater spatial resolution relative to the first sensor.

14. The computer-implemented method of claim 1, wherein the one or more source images comprise natural images that were captured at the first resolution.

15. A computing system for performing an image processing task with improved accuracy, the system comprising:
one or more processors; and
one or more non-transitory computer-readable media that collectively store instructions that, when executed by the one or more processors, cause the computing system to perform operations, the operations comprising:
obtaining, by the computing system, one or more source images and a reference image,
wherein the one or more source images and the reference image all depict an environment,
wherein the one or more source images have a first image resolution, and
wherein the reference image has a second image resolution that is greater than the first image resolution;
processing, by the computing system, the one or more source images with a first machine-learned encoder model to generate one or more source image embeddings;
processing, by the computing system, the reference image with a second machine-learned encoder model to generate a reference image embedding,
wherein the second machine-learned encoder model has been pre-trained jointly with a machine-learned decoder model to perform an image processing task;
processing, by the computing system, a noisy input with a denoising diffusion model that is conditioned on the one or more source image embeddings and the reference image embedding to generate a predicted image embedding; and
processing, by the computing system, the predicted image embedding with the machine-learned decoder model to generate a task prediction for the image processing task.

16. The computing system of claim 15, wherein the task prediction has the second image resolution.

17. The computing system of claim 15, wherein the one or more source images and the reference image are aerial images that depict a geographic area.

18. The computing system of claim 15, wherein the one or more source images depict the environment at a current time, and wherein the reference image depicts the environment at a prior time.

19. The computing system of claim 15, wherein the one or more source images comprise a plurality of images that depict the environment over a time window.

20. The computing system of claim 15, wherein the one or more source images were captured by a first sensor and the reference image was captured by one or more second sensors, the one or more second sensors having greater spatial resolution relative to the first sensor.
